(19) United States
(12) Patent Application Publication
(10) Pub. No.: US 2008/0138490 A1
(43) Pub. Date: Jun. 12, 2008

(54) Shelf-stable liquid beverage concentrate

(75) Inventors: Mark Nash, San Antonio, TX (US); Caroline Messer, Scotts Valley, CA (US)

Correspondence Address: JACKSON WALKER LLP, 901 MAIN STREET, SUITE 6000, DALLAS, TX, 75202-3797, US

(73) Assignee: Aspen Enterprises, Ltd., San Antonio, TX (US)

(21) Appl. No.: 11/977,609

(22) Filed: Oct. 25, 2007

Related U.S. Application Data
(60) Provisional application No. 60/854,767, filed on Oct. 27, 2006.

(51) Int. Cl. A23L 2/38; A23F 3/16; A23F 5/24; A23L 2/02

(52) U.S. Cl. 426/594; 426/590; 426/597; 426/599

(57) ABSTRACT

A liquid beverage concentrate having low viscosity, low water activity, and extended shelf life at ambient temperatures. The liquid beverage concentrate contains a sugar alcohol, a sweetener, a non-dairy creamer, a stabilizing gum, and water. It can optionally contain one or more flavorings, acidulants, colorings, preservatives, and emulsifying agents. The liquid beverage concentrate enables relatively high ratios of finished beverage to concentrate while remaining of sufficiently low viscosity to allow the use of conventional beverage pumps and dispensers.

This application claims priority to U.S. Provisional Patent Application Ser. No. 60/854,767, filed on Oct. 27, 2006, entitled SHELF-STABLE LIQUID BEVERAGE CONCENTRATE, the entire content of which is hereby incorporated by reference.

### BACKGROUND

This invention pertains to a liquid beverage concentrate having low viscosity that is shelf-stable, resistant to microbial growth, and can be stored at ambient temperatures.

The beverage industry utilizes liquid concentrates in bulk packaging to deliver various beverages to the consumer in a convenient manner. Single serve bottled and canned beverages have extremely high packaging, shipping, and storage costs, and may require refrigeration to increase shelf life. By contrast, a powder or concentrate can be mixed with water and rapidly chilled or heated by dispenser systems at the point of consumption. Using high concentrations of beverage, which are then diluted at the final dispensing location, reduces shipping costs by eliminating the shipment of water.

However, beverages prepared from powders or concentrates may be of a lower quality compared to ready-to-consume products due to insufficient or improper mixing and dilution of the concentrate. Although dry mixes or powdered/crystalline formulations are most desirable in terms of transportation and storage, the dry mixes frequently produce beverages with inferior taste and feel due to the difficulties in obtaining complete rehydration and mixing. Beverages prepared from liquid concentrates are more desirable. There is also a limit on the amount of concentration that is feasible for concentrates. The amount of water must be high enough to produce a produce that is readily pumped and mixed to obtain the final beverage. A product that is too viscous requires longer mixing times and possible more agitation.

Liquid concentrates may also require special storage conditions, particularly after being opened. Current industry practices use heat processing technology, such as retort or UHT/aseptic technologies, to produce shelf-stable liquid beverage products from concentrate. These shelf stable beverage concentrates generally have a neutral pH. Thus, when the beverage concentrate container is opened for use, the growth of most microorganisms within the concentrate is supported and the beverage product is highly susceptible to contamination and spoliation. This limits the shelf life of the single strength or reconstituted product.

U.S. Pat. No. 6,376,005 to Bunger et al. pertains to an antimicrobial composition which may be useful in treating dilute beverages to increase their resistance to food spoilage microorganisms.

U.S. Pat. No. 6,350,484 to Ault pertains to a liquid beverage concentrate which is resistant to microbial growth and contains fructose, non-dairy creamer, a combination of xanthan gum and tragacanth gum, flavorings, and water. The low viscosity gums together with a carbohydrate sweetener (fructose) produce a pumpable product, but this concentrate is still susceptible to being overly sweet.

U.S. Pat. No. 6,406,730 to Banyard et al. pertains to a method and apparatus for treating a low acid food product through acidification and deacidification.

U.S. Pat. No. 6,482,456 to Yokoo et al. pertains to a method for producing a low acid beverage with limited deterioration in quality during heat sterilization or heated storage.

U.S. Pat. No. 4,676,988 to Efstathiou et al. pertains to a beverage having a milk component and a juice component which exhibit minimal curdling and precipitation.

What is needed, therefore, is an improved formulation of liquid beverage concentrate which has an extended shelf-life and a resistance to contamination by microorganisms.

### SUMMARY

The present invention relates to a shelf-stable liquid beverage concentrate which has low viscosity, low water activity, and extended shelf-life even at ambient temperatures. The liquid beverage concentrate contains a sugar alcohol, sweetener, non-dairy creamer, stabilizing gum, flavorings, and water. The beverage concentrate enables relatively high ratios of finished beverage to concentrate while remaining of sufficiently low viscosity to allow the use of conventional beverage pumps and dispensers. The liquid beverage concentrate is also resistant to microbial growth without the need for additional preservatives, thereby enabling storage at ambient temperatures.

### DETAILED DESCRIPTION OF PREFERRED EMBODIMENTS

One embodiment of the current invention pertains to a liquid beverage concentrate comprising a sugar alcohol, a sweetener, a non-dairy creamer, a stabilizing gum, and water. Optional additional ingredients include flavorings, acidulants, colorings, preservatives, and emulsifying agents. In a preferred embodiment, the liquid beverage concentrate comprises about 5-25% sugar alcohol, 25-45% sweetener, 18-35% non-dairy creamer, 20-30% water, and about 0.025-0.3% stabilizing gum. Preferably, the liquid beverage concentrate is shelf stable, in that it is stable (both without growth of microorganism, losing its sensory taste, or both) at ambient temperature for up to 3, 6, 12 or more months.

A first component of the liquid beverage concentrate is a sugar alcohol. Preferred sugar alcohols include glycerin and sorbitol. Use of a sugar alcohol in place of carbohydrate sweeteners allows for both lowered water activity and lowered sweetness in addition to lowered viscosity. The most preferred sugar alcohol is glycerin. Based on weight, the sugar alcohol preferably comprises about 5 to about 25% of the liquid beverage concentrate, more preferably about 12 to about 19%, and most preferably about 19%.

An additional component of the liquid beverage concentrate is a sweetener. Preferred sweeteners include sugar, fructose, high fructose corn syrup, or mixtures thereof. Based on weight, the sweetener preferably comprises about 25 to about 45% of the liquid beverage concentrate, more preferably about 25 to about 35%, and most preferably about 26%.

A further component of the liquid beverage concentrate is a non-dairy creamer. The non-dairy creamer can be any non-dairy creamer used conventionally in the beverage industry, such as those manufactured by Diehl. Based on weight, the non-dairy creamer preferably comprises about 18 to about 35% of the liquid beverage concentrate, more preferably about 19 to about 22%, and most preferably about 22%.

Yet another component of the liquid beverage concentrate is a stabilizing gum. Gums are typically used to suspend insoluble solids, such as coffee or cocoa, as well as to add a sense of substance to the mouth feel of the final product. Preferred stabilizing gums include carageenan, xanthan, and pectin. The most preferred stabilizing gum is carageenan. Based on weight, the stabilizing gum preferably comprises about 0.025 to about 0.3% of the liquid beverage concentrate, more preferably from about 0.75 to about 0.25%, and most preferably about 0.10%.

The combination of the non-dairy creamer and the stabilizing gum provides a finished beverage product with a creamy mouth feel. The non-dairy creamer can also work in combination with the sugar alcohol and the sweetener to reduce the water activity of the liquid beverage concentrate. The non-dairy creamer can also work in combination with the stabilizing gums and the sweetener, especially fructose, to reduce the water activity of the liquid beverage concentrate. A practical upper limit to the combination of non-dairy creamer and stabilizing gums is the point where the combination produces a liquid with a viscosity too high to be pumped, measured or mixed effectively, or a finished beverage product with a mouth feel that is too thick or chalky.

An additional component of the liquid beverage concentrate is a water-based component, such as water or a water-based extract or water-based concentrate. Examples of water-based extracts and water-based concentrates include juice, coffee, or tea. Preferred water-based components are water and coffee extract. Based on weight, the water-based component preferably comprises about 20 to about 30% of the liquid beverage concentrate, preferably about 25 to about 27%, and most preferably about 27%.

Optional additional components include flavorings, acidulants, colorings, preservatives, and emulsifying agents.

Flavorings are of particular importance to the liquid beverage concentrate and can be present individually or in any desirable combination. Any conventional flavorings are suitable for use in the concentrate. Flavorings can be used individually or in combination. Preferred flavorings include coffee, cappuccino, tea, cocoa, fruit juice, and chocolate. For each flavoring independently, based on weight, the flavoring preferably comprises about 0.1 to about 3.0% of the liquid beverage concentrate. A preferred total flavoring concentration, based on weight, is about 0.4 to about 10% of the liquid beverage concentrate, and preferably about 2.5 to about 8%.

Other optional ingredients include acidulants, preservatives, colorings, and emulsifiers. Acidulants that can be used in the liquid beverage concentrate include acids such as lactic acid. Preservatives are added to enhance the shelf-life of the diluted, finished product, rather than the liquid beverage concentrate. The liquid beverage concentrate itself is resistant to microbial growth without the addition of extra preservatives and can be stored at ambient temperatures without refrigeration. Preferred preservatives include potassium sorbate. Any conventional food colorings can be used. Preferred emulsifiers include sorbitan monostearate. The limitations on the additions of all of these optional components are variable dependent on their final effect on taste, mouth feel, and viscosity.

Preferably, the overall viscosity of the liquid beverage concentrate should remain sufficiently low to enable the use of conventional beverage pumps and dispensers. Any additional additives should not adversely affect the taste and mouth feel of the final beverage product.

The liquid beverage concentrate has lowered water activity, which is necessary for effective preservation from microbial growth. Common pathogenic bacteria do not effectively propagate in media with a water activity of less than 0.83. Water activity is a food industry measure of relative water vapor pressure of a solution at a given temperature compared to pure water. It correlates to the amount of water available to support microbial growth, or free water. The majority of particularly hazardous bacteria can not effectively propagate in media with water activities less than 0.85.

The liquid beverage concentrate can be packaged in a number of different ways. Suitable packaging could include plastic, foil, multi-layered pouches, or bags in a variety of sizes. These packages can be a variety of sizes, from several fluid ounces to several gallons for use with automatic equipment, lined boxes, glass or plastic jugs, drums, bottles, and canisters. One preferred packaging format is the “bag-in-a-box” packaging used in automated soda fountain mixing machines.

To provide a ready to serve liquid beverage from the liquid beverage concentrate, the concentrate is mixed with water or carbonated water to obtain a homogeneous dilution of the concentrate. Mixing can be accomplished by any conventional means known in the industry. These means include conventional soda fountains, “bag-in-a-box” type beverage concentrate mixing and dispensing machines, blenders, soft-serve ice cream machines, and “slush” machines.

In a preferred example, the final beverage product is formulated by mixing the concentrate with between about three and about six volumes of water. Lower concentrations of the concentrate are acceptable, resulting in the need for less water, but lower concentrations would not have the benefit of a reduced product bulk and might not have a water activity low enough to provide effective bacteriostatic conditions. The practical upper limit on the concentration is, again, dependent on its final viscosity.

An advantage of the liquid beverage concentrate is that it can be stored at ambient temperatures without refrigeration and without additional preservatives and is still resistant to microbial growth and still substantially maintains its sensory taste after 3, 6, 9, 12 or more months.

### Example 1

A preferred beverage concentrate has the following formulation:

| | |
|---|---|
| Liquid Coffee Extract | 28% |
| High Fructose Corn Syrup | 26% |
| Glycerin | 19% |
| Richmix | 22% |
| Natural and Artificial Flavorings | 3.35% |
| Caramel Color | 1% |
| Salt | 0.34% |
| Carageenan | 0.1% |
| Sorbitan Monostearate | 0.08% |
| Potassium Sorbate | 0.13% |

### Example 2

Another preferred beverage concentrate has the following formulation:

| | |
|---|---|
| Liquid Coffee Extract | 26% |
| HFCS | 25% |
| Glycerine | 12% |
| Sugar | 12% |
| Richmix | 20% |
| Nat. and Art. Flavor | 4.75% |
| Carrageenan | 0.08% |
| Sorbitan Monostearate | 0.05% |
| Potassium Sorbate | 0.12% |

It is understood that the preferred embodiments described above are intended only to promote an understanding of the principles of the invention. No limitation of the scope of the invention is intended. All alterations and further modifications to the embodiments, as well as any further applications of the principles of the invention described herein, are all contemplated as being within the scope of the invention as they would normally occur to one skill in the relevant art.

### REFERENCES CITED

The following U.S. Patent documents and publications are hereby incorporated by reference.

### U.S. PATENT DOCUMENTS

U.S. Pat. No. 6,376,005 to Bunger et al.
U.S. Pat. No. 6,350,484 to Ault
U.S. Pat. No. 6,406,730 to Banyard et al.
U.S. Pat. No. 6,482,456 to Yokoo et al.
U.S. Pat. No. 4,676,988 to Efstathiou et al.

What is claimed is:

1. A liquid beverage concentrate comprising a sugar alcohol, a sweetener, a non-dairy creamer, a stabilizing gum, and a water-based component.

2. The liquid beverage concentrate of claim 1, wherein, based on the total weight percentage of the liquid beverage concentrate, the sugar alcohol is present from about 5 to about 25%, the sweetener is present from about 25 to about 45%, the non-dairy creamer is present from about 18 to about 35%, the stabilizing gum is present from about 0.025 to about 0.3%, and the water-based component is present from about 20 to about 30%.

3. The liquid beverage concentrate of claim 1, wherein the sugar alcohol is glycerin or sorbitol.

4. The liquid beverage concentrate of claim 1, wherein the sweetener is sugar, fructose, high fructose corn syrup, or mixtures thereof.

5. The liquid beverage concentrate of claim 1, wherein the stabilizing gum is carageenan, xanthan, or pectin.

6. The liquid beverage concentrate of claim 1, wherein the water-based component is water, a water-based extract, or a water-based concentrate.

7. The liquid beverage concentrate of claim 6, wherein the water-based component is coffee extract.

8. The liquid beverage concentrate of claim 1, wherein the water-based component is juice, coffee, or tea.

9. The liquid beverage concentrate of claim 1, further comprising one or more flavorings.

10. The liquid beverage concentrate of claim 9, wherein the one or more flavorings is present from about 0.1 to about 6%, based on the total weight percentage of the liquid beverage concentrate.

11. The liquid beverage concentrate of claim 1, further comprising one or more acidulants.

12. The liquid beverage concentrate of claim 11, wherein the one or more acidulants is lactic acid.

13. The liquid beverage concentrate of claim 1, further comprising one or more preservatives.

14. The liquid beverage concentrate of claim 13, wherein the one or more preservatives is potassium sorbate.

15. The liquid beverage concentrate of claim 1, further comprising one or more colorings.

16. The liquid beverage concentrate of claim 1, further comprising one or more emulsifying agents.

17. The liquid beverage concentrate of claim 16, wherein the one or more emulsifying agents is sorbitan monostearate.

18. A liquid beverage concentrate comprising, based on the total weight percentage of the liquid beverage concentrate:
about 19% glycerin;
about 26% fructose;
about 27% coffee extract;
about 22% non-dairy creamer; and
about 0.15% stabilizing gum.

19. The liquid beverage concentrate of claim 18, further comprising about 2.5 to about 6% of one or more flavorings.

20. A liquid beverage concentrate effective for mixing with water or carbonated water in a ratio of concentrate to water of between about 1:3 and about 1:6, to provide a liquid beverage, comprising a sugar alcohol, a sweetener, a non-dairy creamer, a stabilizing gum, and a water-based component.

21. The liquid beverage concentrate of claim 20, wherein, based on the total weight percentage of the liquid beverage concentrate, the sugar alcohol is present from about 5 to about 25%, the sweetener is present from about 25 to about 45%, the non-dairy creamer is present from about 18 to about 35%, the stabilizing gum is present from about 0.025 to about 0.3%, and the water-based component is present from about 20 to about 30%.

22. The liquid beverage concentrate of claim 20, further comprising one or more flavorings, acidulants, colorings, preservatives, and emulsifying agents.

23. A method of preparing a liquid beverage comprising:
mixing a liquid beverage concentrate with water or carbonated water in a ratio of between about 1:3 and about 1:6, to provide a liquid beverage,
wherein the liquid beverage concentrate comprises:
about 5 to about 25% glycerin;
about 25 to about 45% fructose;
about 20 to about 30% coffee extract;
about 18 to about 35% non-dairy creamer;
about 0.025 to about 0.3% stabilizing gum; and
about 0.1 to about 6% flavorings.
